(19) United States
(12) Patent Application Publication
(10) Pub. No.: US 2006/0228264 A1
(43) Pub. Date: Oct. 12, 2006

(54) Tube

(76) Inventors: Roy Garvin, Gold Hill, OR (US); Alasdair Burns, Glasgow (BE)

Correspondence Address: Fish & Richardson, Suite 3300, 60 South Sixth Street, Minneapolis, MN, 55402, US

(21) Appl. No.: 10/525,127

(22) PCT Filed: Aug. 19, 2003
(86) PCT No.: PCT/GB03/03628

§ 371 Date: Apr. 5, 2006

(30) Foreign Application Priority Data
Aug. 19, 2002 (GB) 0219291.2

(51) Int. Cl. B01L 3/00; B32B 27/04; B32B 27/12; B32B 5/02

(52) U.S. Cl. 422/102

(57) ABSTRACT

A novel microtube is provided comprising: a container having an open end defining an opening for receiving materials to be contained, and a closed end; and a lid adapted to make closing contact with the opening of the container; wherein the lid is provided with a flange extending outwardly therefrom, and arranged to move towards the closed end of the container upon application of a mechanical force to a surface of the flange so as to remove the closing contact, whereby the container is opened.

The present invention relates to microtubes and further to apparatus, for example, centrifuges comprising microtubes according to) the invention.

Microtubes tend to comprise a container and separate screw tops, snap caps or attached caps. The screw top and snap cap require two hands to remove the tops. The attached caps must be pushed up with a thumb or forefinger, and also require two hands. One-handed operation can be attempted, however, in practice this is very difficult and often results in contamination of the underside of the lid and/or the user's hands. The movements used put a strain on the thumb, causing chaffing, swelling, bruising and associated discomfort. After extended use this can lead to repetitive strain injury.

Attempts have been made to alleviate the problems by developing tools to assist in the opening of the tubes. While removing some of the strain involved in opening the tube, such devices require a two handed operation. In addition these tools are easily misplaced, dropped or lost.

A microtube is opened during routine use to add or extract material. Generally the handler has a pipette or similar measurement device in one hand and the tube in the other. Two handed opening requires the operator to set down the pipette or tube. This can cause contamination and is physically awkward. If this operation is attempted one-handed, it also can cause contamination to the tube and the chaffing and bruising mentioned above. Such operation can lead over time to repetitive strain injury.

In an attempt to address some of the problems regarding contamination when using conventional tubes, a microcentrifuge tube has been designed which has a tab attached to the lid of the tube to assist with opening the tube (U.S. Pat. No. 5,382,408). In order to open this tube an upward force is applied to the tab which allows the lid to be removed from the tube without contact with any other portion of the lid.

However, since microcentrifuge tubes are routinely used as containers for the storage of toxic and radioactive chemicals, tubes whose lid opens toward the face and body of the user are undesirable due to the risk of contamination of the user by the contents of the tube spraying out when the lid is snapped open.

According to a first aspect of the present invention there is provided a microtube comprising:

a container having an open end defining an opening for receiving materials to be contained, and a closed end;

a lid adapted to make closing contact with the opening of the container;

wherein the lid is provided with a flange extending outwardly therefrom, and arranged to move towards the closed end of the container upon application of a mechanical force to a surface of the flange so as to remove the closing contact, whereby the container is opened.

As used herein, the term “microtube” is intended to encompass any laboratory container e.g. a small test tube or microcentrifuge tube suitable for storing or centrifuging small amounts of liquid, for example, up to 4 ml, for example 2 ml, 1.5 ml or 0.5 ml or 0.2 ml tubes.

Preferable the microtube is a microcentrifuge tube, commonly referred to as a microfuge tube.

Preferably, the lid is connected to the container by a connecting means which itself preferably provides for relative movement between the lid/flange and the container.

Such aconnecting means may, for example, comprise a hinge, a flexible connecting strip, rivet, adhesive or any other suitable connecting means. Preferably the connecting means comprises a hinge which may be fixed to the upper perimeter wall of the container defining the opening, and to the lower surface of the lid, and about which the lid/flange and container can move.

The microtube may be made from any plastics material, preferably from laboratory grade injection moulded plastic. The lid and flange parts of the tube can be made either as an integral part of the container or can be attached to the container (e.g. a glass test tube).

In another preferred embodiment the flange also finds use as a handle by which the microtube can be easily handled, eg for insertion/removal from laboratory apparatus.

In one embodiment of the invention there is provided a microtube comprising:

a container having an open end defining an opening, for receiving materials to be contained, and a closed end;

a lid connected to the container by a hinge and adapted to make closing contact with the opening of the container;

a flange extending outwardly from the lid, wherein the hinge is connected to the lid at a position between the lid and the flange such that upon application of a mechanical force to the surface of the flange, the lid and flange are arranged to pivot about the hinge so as to remove the closing contact between the lid and the container whereby the container is opened.

Preferably, the microtube is a microcentrifuge tube and the lid is adapted to make a sealing contact with the opening of the container.

Preferably, the lid is adapted so that the flange extends outwardly from a position adjacent to, or in axial alignment with, the hinge. In a particularly preferred embodiment, the flange extends upwards, ie at an angle of approximately 90°.

The flange is preferably of a length which allows it to be conveniently grasped by the handler thereby allowing for rapid and easy removal of the tube, for example, from a rotor. Removal can be accomplished by grasping the flange with the thumb and forefinger thereby making the operation one handed since forceps or other grasping devices are not required.

Preferably, the mechanical force is applied downwardly to an upper surface of the flange (when the container is viewed with the lid at the top and the closed end at the bottom).

By providing a microtube that comprises a lid having a flange extending outwardly from the lid so that mechanical force applied downwardly to the upper surface of the flange opens the lid, the handler is able to open the tube with ease and using only one hand. This means that the handler is able to handle other tubes whilst keeping other instruments e.g. for dispensing, in the other hand thereby eliminating the risk of contamination of the tubes or instruments by contact with the work surface.

Since the lid of the microtube is opened by the application of mechanical force applied downwardly to the upper surface of the flange, the open lid may act as a shield between the object applying the mechanical force, for example the thumb of the handler, and the tube opening thereby avoiding contamination of the tube or sample which might otherwise occur with conventional tubes.

The microtubes of the invention may be useful for, inter alia, storage of materials contained in the tube e.g. in the deep freeze, as reaction vessels and for centrifugation e.g. in the microfuge rotor of the materials in the tube.

When viewed as an upright (i.e. lid at top) closed microfuge tube, the flange comprises an outward projection, preferably suitably angled relative to a generally horizontal surface defining an upper surface of the lid to allow for optimum leverage to facilitate easy opening and closing of the lid. Preferably, the angle and length of the flange are such that when an upward component of force is applied to the flange, the lid is unseated and the container opened.

In a second aspect, the invention comprises a storage system/vessel e.g. a rack, a reaction vessel or a centrifuge e.g. microfuge/rotor microcentrifuge comprising a microtube of the invention.

It is preferred that the flange is attached to the lid within the half of the lid proximal to the hinge. This location of the flange provides leverage to facilitate the opening of the container. In a third aspect, the invention provides a method for opening a closed microtube according to the invention, the method comprising applying pressure to a upper surface of the flange to break the closing/sealing contact between the lid and the container, such that the lid and the flange are pivoted about the hinge to open the container. Preferably, this method allows for opening a microtube of the invention without contaminating the inside of the lid, container or the container contents

The present invention will now be described by way of example only and with reference to the accompanying drawings in which:

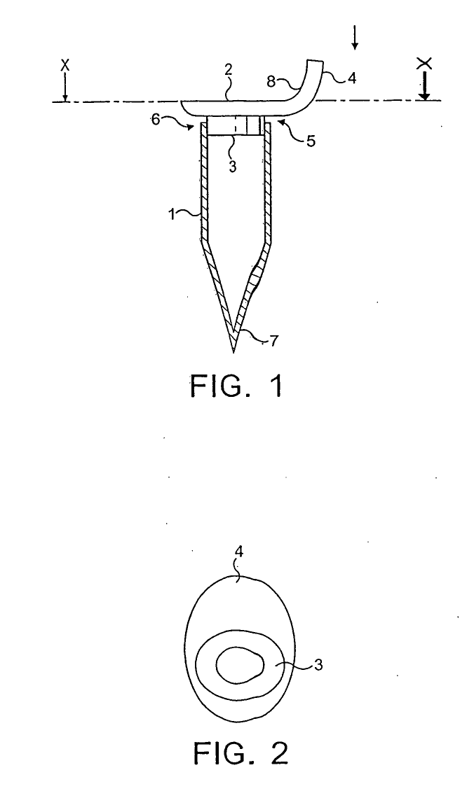

FIG. 1A front view of a closed microtube of the invention.

FIG. 2 A cross-sectional of the microtube as shown in FIG. 1, taken along Line X-X.

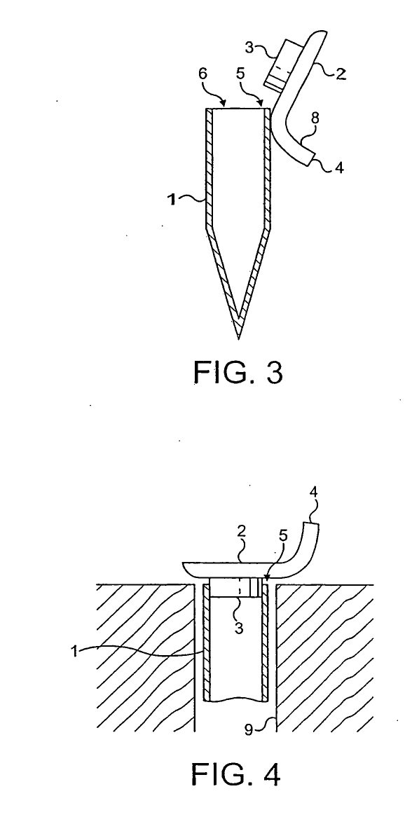

FIG. 3 A front view of an open microtube of the invention.

FIG. 4 Sectional view of a microtube of the invention inserted in a microfuge rotor.

FIG. 1 of the accompanying drawings illustrates an embodiment of the microtube (1) according to the invention. The microtube (1) is approximately 4 cm in length and 1 cm in diameter, however the flange extends the diameter by up to 2 cm.

The tube (1) includes a container (7) having a circular opening (6) defined by an upper perimeter wall, for receiving materials to be contained in the tube. A lid (2) is connected to the perimeter wall of the opening (6) by a fixed tinge (5). The lower surface of the lid (3) makes sealing contact with the perimeter wall of the opening (6) thereby enclosing the contents of the container inside the tube.

The lid (2) has an upwardly and backwardly extending extension (4) that is integrally formed with the lid. The extension (4) extends from the lid (2) at a position adjacent to the hinge (5). Thumb pressure applied downwardly (in the direction of the arrow shown in FIG. 1) to the upper surface (8) of the extension (4) breaks the sealing contact between the opening (6) and the lid (2) thereby opening the tube. The open lid (2) then acts as a guard to protect the tube (1) from contamination by the handler's thumb/finger(s).

The upper surface (8) of the extension (4) is sloped away from the hinge (5) so that pushing on the upper surface (8) in the direction shown by the arrow in FIG. 1, provides an upward component of force to unseat the lid (2) and open the container.

The lid is re-sealed by the application of a downward pressure (in the direction of the arrow in FIG. 1) to the upper surface of the part of the lid (2) which is not the extension (4).

In the practice of opening a frictionally sealed tube (1) having a hinged lid (2) with an upwardly angled lid extension (4), the tube (1) is held in the handlers hand, a microfuge rotor (9) (FIG. 4) or in another holding means which immobilises the tube (1) and does not interfere with opening of the lid. Thumb pressure is applied to the lit extension (4) generally in the direction of the lid hinge (5) to unseal the lid and open the container.

Various modifications may be made to the microtube of the invention without departing from the scope thereof For example, the microtube may be provided with additional structural modifications which allow the tube to be grasped, or secured in a holding device, with ease. Also, the container may be of any suitable shape which enables the lid and flange to be securely mounted/fixed thereon.

The microtubes may be of a disposable type which are intended to be fused only once by the user and are then thrown away. Preferably, the microtubes are formed from materials capable of withstanding high temperatures, for example, ranging from 130° C. to −200° C. Preferably, the microtubes are autoclavable and are RNase and DNase free.

1. A microtube comprising:
a container having an open end defining an opening for receiving materials to be contained, and a closed end; and
a lid adapted to make closing contact with the opening of the container; wherein the lid is provided with a flange extending outwardly therefrom, and arranged to move towards the closed end of the container upon application of a mechanical force to a surface of the flange so as to remove the closing contact, whereby the container is opened.

2. A microtube as claimed in claim 1 which is a test tube or microcentrifuge (microfuge) tube suitable for holding relatively small volumes of material.

3. A microtube as claimed in claim 2 wherein the relatively small volume of material is a volume up to 4 ml.

4. A microtube as claimed in claim 1 which is a microfuge tube.

5. A microtube as claimed claim 1 wherein the lid is adapted to make a sealing contact with the opening of the container.

6. A microtube as claimed in claim 1 wherein the lid is connected to the container by a connecting means.

7. A microtube as claimed in claim 6 wherein the connecting means provides for relative movement between the lid/flange and the container.

8. A microtube as claimed in claim 7 wherein the connecting means is a hinge, flexible connecting strip, rivet or adhesive.

9. A microtube as claimed in claim 8 wherein the connecting means comprises a hinge which may be fixed to the upper perimeter wall of the container defining the opening, and to the lower surface of the lid, and about which the lid/flange and container can move.

10. A microtube as claimed in claim 1 wherein the lid is adapted such that the flange extends outwardly from a position adjacent to or in axial alignment with the connection means.

11. A microtube as claimed in claim 10 wherein the flange extends upwardly.

12. A microtube as claimed in claim 1 which is constructed of a plastics material.

13. A microtube as claimed in claim 12 wherein the plastics material is laboratory grade injection moulded plastic.

14. A microtube as claimed in claim 1 wherein the lid and flange parts of the tube are made as an integral part of the container.

15. A microtube as claimed in claim 1 wherein the flange is used adapted for use as a handle.

16. A microtube comprising:
a container having an open end defining an opening for receiving materials to be contained, and a closed end;
a lid connected to the container by a hinge and adapted to make closing contact with the opening of the container; and
a flange extending outwardly from the lid, wherein the hinge is connected to the lid at a position between the lid and the flange such that upon application of a mechanical force to the surface of the flange, the lid and flange are arranged to pivot about the hinge so as to remove the closing contact between the lid and the container whereby the container is opened.

17. A storage system/vessel comprising one or more microtubes as defined in claim 1.

18. A storage system as claimed in claim 17 wherein the storage system/vessel is a rack, a reaction vessel or a centrifuge.

19. The use of a microtube as defined in claim 1 for the storage of material, as reaction vessels or in centrifugation.
